(19) United States
(12) Patent Application Publication
(10) Pub. No.: US 2014/0282584 A1
(43) Pub. Date: Sep. 18, 2014

(54) Allocating Accelerators to Threads in a High Performance Computing System

(71) Applicant: Silicon Graphics International Corp., Fremont, CA (US)

(72) Inventor: Karl Allan Feind, Bloomington, MN (US)

(73) Assignee: Silicon Graphics International Corp., Fremont, CA (US)

(21) Appl. No.: 13/900,757

(22) Filed: May 23, 2013

Related U.S. Application Data
(60) Provisional application No. 61/783,544, filed on Mar. 14, 2013.

(51) Int. Cl. G06F 9/50

(52) U.S. Cl. CPC G06F 9/5061
USPC 718/104

(57) ABSTRACT

A method of distributing threads among accelerators in a high performance computing system receives a request to assign an accelerator in the computing system to a thread. The request includes a mode indicative of location and exclusivity of the accelerator for use by the thread. The method selects the accelerator according to a processor assigned to the thread. The method also assigns the accelerator to the thread with the exclusivity specified in the request.

### PRIORITY

This patent application claims priority from provisional U.S. patent application No. 61/783,544, filed Mar. 14, 2013 and entitled, “ALLOCATING ACCELERATORS TO THREADS IN A HIGH PERFORMANCE COMPUTING SYSTEM,” the disclosure of which is incorporated herein, in its entirety, by reference.

### FIELD OF THE INVENTION

The invention generally relates to resource management in a high performance computing system and, more particularly, the invention relates to allocating accelerators in a high performance computing system among threads.

### BACKGROUND OF THE INVENTION

High performance computing environments include processors and accelerators that are distributed across the processor interconnect network. When software threads execute on processors that are distant from the accelerators that they are using, the threads experience long communication latency and reduced communication bandwidth.

### SUMMARY OF VARIOUS EMBODIMENTS

In accordance with one embodiment of the invention, a method of distributing threads among accelerators in a high performance computing system receives a request to assign an accelerator in the computing system to a thread. The request includes a mode indicative of location and exclusivity of the accelerator for use by the thread. The method selects the accelerator according to a processor assigned to the thread. The method also assigns the accelerator to the thread with the exclusivity specified in the request.

In some embodiments, the method receives an identifier of the accelerator to assign to the thread. The method may also include determining from the mode that the thread requires exclusive use of the accelerator, and storing a record indicating the thread to which the accelerator is exclusively assigned. In various embodiments, the method uncouples threads that are already executing on the accelerator from the accelerator, selects a second accelerator to execute the threads, and assigns the second accelerator to the threads.

In some embodiments, the method includes receiving a reference accelerator from which the allocator begins searching for the accelerator to assign to the thread. The method may also determine that an accelerator proximate to the reference accelerator is available. In some embodiments, the method reads a record that stores a status of the accelerator. Further, the method may iteratively determine availability of accelerators in order of proximity to the reference accelerator until an available accelerator is found. The method may also determine from the mode that the thread requires exclusive use of the accelerator. The method may store a record indicating that the accelerator is unavailable.

Illustrative embodiments of the invention are implemented as a high performance computer system having at least one partition. Each partition has a plurality of nodes that cooperate to perform a computation. Each node in the partition includes at least one computing processor and a local memory that is coupled to the at least one computing processor. A subset of the computer processors of the nodes are each directly coupled to at least one accelerator. An allocator of the partition being executed by at least one computing processor is configured to perform the operations described herein.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a logical view of an HPC system in accordance with one embodiment of the present invention.

FIG. 2 schematically shows a physical view of the HPC system of FIG. 1.

FIG. 3 schematically shows details of a blade chassis of the HPC system of FIG. 1.

FIG. 4 schematically shows an exemplary arrangement of processor, only a subset of which are directly coupled to accelerators.

FIG. 5 is an exemplary flow diagram for processing a request to assign a thread to an accelerator.

FIG. 6 is an exemplary flow diagram for selecting an accelerator to run a thread in the “Local” mode.

FIG. 7 is an exemplary flow diagram for selecting an accelerator to run a thread in the “Local_Shared” mode.

FIG. 8 is an exemplary flow diagram for selecting an accelerator to run a thread in the “Near” mode.

FIG. 9 is an exemplary flow diagram for selecting an accelerator to run a thread in the “Near_Shared” mode.

FIG. 10 is an exemplary flow diagram for selecting an accelerator to run a thread in the “Properties” mode.

### DESCRIPTION OF ILLUSTRATIVE EMBODIMENTS

In illustrative embodiments, a high performance computer system instructs an allocator to intelligently assign accelerators to threads in a manner that should improve system performance. To that end, the system may use a request having a mode, associated with a thread, specifying criteria for selecting an appropriate accelerator. Details of illustrative embodiments are discussed below.

### System Architecture

FIG. 1 schematically shows a logical view of an exemplary high-performance computing system 100 that may be used with illustrative embodiments of the present invention. Specifically, as known by those in the art, a “high-performance computing system,” or “HPC system,” is a computing system having a plurality of modular computing resources that are tightly coupled using hardware interconnects, so that processors (also referred to herein as logical CPUs) may access remote data directly using a common memory address space.

The HPC system 100 includes a number of computing partitions 120, 130, 140, 150, 160, 170 for providing computational resources, and a system console 110 for managing the plurality of partitions 120-170. A “computing partition” (or “partition”) in an HPC system is an administrative allocation of computational resources that runs a single operating system instance and has a common memory address space. Partitions 120-170 may communicate with the system console 110 using a logical communication network 180. A system user, such as a scientist or engineer who desires to perform a calculation, may request computational resources from a system operator, who uses the system console 110 to allocate and manage those resources. The HPC system 100 may have any number of computing partitions that are administratively assigned as described in more detail below, and often has only one partition that encompasses all of the available computing resources. Accordingly, this figure should not be seen as limiting the scope of the invention.

Each computing partition, such as partition 160, may be viewed logically as if it were a single computing device, akin to a desktop computer. Thus, the partition 160 may execute software, including a single operating system (“OS”) instance 191 that uses a basic input/output system (“BIOS”) 192 as these are used together in the art, and application software 193 for one or more system users.

Accordingly, as also shown in FIG. 1, a computing partition has various hardware allocated to it by a system operator, including one or more processors 194 (e.g., logical CPUs), volatile memory 195, non-volatile storage 196, and input and output (“I/O”) devices 197 (e.g., network ports, video display devices, keyboards, and the like). However, in HPC systems like the embodiment in FIG. 1, each computing partition has a great deal more processing power and memory than a typical desktop computer. The OS software may include, for example, a Windows® operating system by Microsoft Corporation of Redmond, Wash., or a Linux operating system. Moreover, although the BIOS may be provided as firmware by a hardware manufacturer, such as Intel Corporation of Santa Clara, Calif., it is typically customized according to the needs of the HPC system designer to support high-performance computing, as described below in more detail.

As part of its system management role, the system console 110 acts as an interface between the computing capabilities of the computing partitions 120-170 and the system operator or other computing systems. To that end, the system console 110 issues commands to the HPC system hardware and software on behalf of the system operator that permit, among other things: 1) booting the hardware, 2) dividing the system computing resources into computing partitions, 3) initializing the partitions, 4) monitoring the health of each partition and any hardware or software errors generated therein, 5) distributing operating systems and application software to the various partitions, 6) causing the operating systems and software to execute, 7) backing up the state of the partition or software therein, 8) shutting down application software, and 9) shutting down a computing partition or the entire HPC system 100. These particular functions are described in more detail in the section below entitled “System Management Functions.”

FIG. 2 schematically shows a physical view of a high performance computing system 100 in accordance with the embodiment of FIG. 1. The hardware that comprises the HPC system 100 of FIG. 1 is surrounded by the dashed line. The HPC system 100 is connected to a user data network 210 to facilitate user access.

The HPC system 100 includes a system management node (“SMN”) 220 that performs the functions of the system console 110. The management node 220 may be implemented as a desktop computer, a server computer, or other similar computing device, provided either by the user or the HPC system designer, and includes software necessary to control the HPC system 100 (i.e., the system console software).

The HPC system 100 is accessible using the data network 210, which may be inclusive of any data network known in the art, such as a local area network (“LAN”), a virtual private network (“VPN”), the Internet, or a combination of these networks, or the like. Any of these networks may permit a number of users to access the HPC system resources remotely and/or simultaneously. For example, the management node 220 may be accessed by a user computer 230 by way of remote login using tools known in the art such as Windows® Remote Desktop Services or the Unix secure shell. If the user is so inclined, access to the HPC system 100 may be provided to a remote computer 240. The remote computer 240 may access the HPC system by way of a login to the management node 220 as just described, or using a gateway or proxy system as is known to persons in the art.

The hardware computing resources of the HPC system 100 (e.g., the processors, such as logical CPUs; memory, non-volatile storage, and I/O devices shown in FIG. 1) are provided collectively by one or more “blade chassis,” such as blade chassis 252, 254, 256, 258 shown in FIG. 2, that are managed and allocated into computing partitions. A blade chassis is an electronic chassis that is configured to house, power, and provide high-speed data communications between a plurality of stackable, modular electronic circuit boards called “blades.” Each blade includes enough computing hardware to act as a standalone computing server. The modular design of a blade chassis permits the blades to be connected to power and data lines with a minimum of cabling and vertical space.

Accordingly, each blade chassis, for example blade chassis 252 (FIG. 3, discussed below), has a chassis management controller 260 (also referred to as a “chassis controller” or “CMC”) for managing system functions in the blade chassis 252, and a number of blades 262, 264, 266 for providing computing resources. Each blade, for example blade 262, contributes its hardware computing resources to the collective total resources of the HPC system 100. The system management node 220 manages the hardware computing resources of the entire HPC system 100 using the chassis controllers, such as chassis controller 260, while each chassis controller in turn manages the resources for just the blades in its blade chassis. The chassis controller 260 is physically and electrically coupled to the blades 262-266 inside the blade chassis 252 by means of a local management bus 268, described below in more detail. The hardware in the other blade chassis 254-258 is similarly configured.

The chassis controllers communicate with each other using a management connection 270. The management connection 270 may be a high-speed LAN, for example, running an Ethernet communication protocol, or other data bus. By contrast, the blades communicate with each other using a computing connection 280. To that end, the computing connection 280 illustratively has a high-bandwidth, low-latency system interconnect, such as NUMAlink, developed by Silicon Graphics International Corp. of Fremont, Calif.

The chassis controller 260 provides system hardware management functions to the rest of the HPC system. For example, the chassis controller 260 may receive a system boot command from the SMN 220, and respond by issuing boot commands to each of the blades 262-266 using the local management bus 268. Similarly, the chassis controller 260 may receive hardware error data from one or more of the blades 262-266 and store this information for later analysis in combination with error data stored by the other chassis controllers. In some embodiments, such as that shown in FIG. 2, the SMN 220 or a user computer 230 are provided access to a single, master chassis controller 260 that processes system management commands to control the HPC system 100 and forwards these commands to the other chassis controllers. In other embodiments, however, an SMN 220 is coupled directly to the management connection 270 and issues commands to each chassis controller individually. Persons having ordinary skill in the art may contemplate variations of these designs that permit the same type of functionality, but for clarity only these designs are presented.

The blade chassis 252, its blades 262-266, and the local management bus 268 may be provided as known in the art. However, the chassis controller 260 may be implemented using hardware, firmware, or software provided by the HPC system designer. Each blade provides the HPC system 100 with some quantity of processors (e.g., logical CPUs), volatile memory, non-volatile storage, and I/O devices that are known in the art of standalone computer servers. However, each blade also has hardware, firmware, and/or software to allow these computing resources to be grouped together and treated collectively as computing partitions, as described below in more detail in the section entitled “System Management Functions.”

While FIG. 2 shows an HPC system 100 having four chassis and three blades in each chassis, it should be appreciated that these figures do not limit the scope of the invention. An HPC system may have dozens of chassis and hundreds of blades; indeed, HPC systems often are desired because they provide very large quantities of tightly-coupled computing resources.

FIG. 3 schematically shows a single blade chassis 252 in more detail. In this figure, parts not relevant to the immediate description have been omitted. The chassis controller 260 is shown with its connections to the system management node 220 and to the management connection 270. The chassis controller 260 may be provided with a chassis data store 302 for storing chassis management data. In some embodiments, the chassis data store 302 is volatile random access memory (“RAM”), in which case data in the chassis data store 302 are accessible by the SMN 220 so long as power is applied to the blade chassis 252, even if one or more of the computing partitions has failed (e.g., due to an OS crash) or a blade has malfunctioned. In other embodiments, the chassis data store 302 is non-volatile storage such as a hard disk drive (“HDD”) or a solid state drive (“SSD”). In these embodiments, data in the chassis data store 302 are accessible after the HPC system has been powered down and rebooted.

FIG. 3 shows relevant portions of specific implementations of the blades 262 and 264 for discussion purposes. The blade 262 includes a blade management controller 310 (also called a “blade controller” or “BMC”) that executes system management functions at a blade level, in a manner analogous to the functions performed by the chassis controller at the chassis level. For more detail on the operations of the chassis controller and blade controller, see the section entitled “System Management Functions” below. The blade controller 310 may be implemented as custom hardware, designed by the HPC system designer to permit communication with the chassis controller 260. In addition, the blade controller 310 may have its own RAM 311 to carry out its management functions. The chassis controller 260 communicates with the blade controller of each blade using the local management bus 268, as shown in FIG. 3 and the previous figures.

The blade 262 also includes one or more processors 320, 322 (e.g., logical CPUs) that are connected to RAM 324, 326. Blade 262 may be alternately configured so that multiple processors (e.g., logical CPUs) may access a common set of RAM on a single bus, as is known in the art. It should also be appreciated that processors 320, 322 may include any number of central processing units (“CPUs”) or cores, as is known in the art. The processors 320, 322 in the blade 262 are connected to other items, such as a data bus that communicates with I/O devices 332, a data bus that communicates with non-volatile storage 334, and other buses commonly found in standalone computing systems. (For clarity, FIG. 3 shows only the connections from processor 320 to these other devices.) The processors 320, 322 may be, for example, Intel© Core™ processors manufactured by Intel Corporation. The I/O bus may be, for example, a PCI or PCI Express (“PCIe”) bus. The storage bus may be, for example, a SATA, SCSI, or Fibre Channel bus. It will be appreciated that other bus standards, processor types, and processor manufacturers may be used in accordance with illustrative embodiments of the present invention.

Each blade (e.g., the blades 262 and 264) includes an application-specific integrated circuit 340 (also referred to as an “ASIC”, “hub chip”, or “hub ASIC”) that controls much of its functionality. More specifically, to logically connect the processors (e.g., logical CPUs) 320, 322, RAM 324, 326, and other devices 332, 334 together to form a managed, multi-processor, coherently-shared distributed-memory HPC system, the processors (e.g., logical CPUs) 320, 322 are electrically connected to the hub ASIC 340. The hub ASIC 340 thus provides an interface between the HPC system management functions generated by the SMN 220, chassis controller 260, and blade controller 310, and the computing resources of the blade 262.

In this connection, the hub ASIC 340 connects with the blade controller 310 by way of a field-programmable gate array (“FPGA”) 342 or similar programmable device for passing signals between integrated circuits. In particular, signals are generated on output pins of the blade controller 310, in response to commands issued by the chassis controller 260. These signals are translated by the FPGA 342 into commands for certain input pins of the hub ASIC 340, and vice versa. For example, a “power on” signal received by the blade controller 310 from the chassis controller 260 requires, among other things, providing a “power on” voltage to a certain pin on the hub ASIC 340; the FPGA 342 facilitates this task.

The field-programmable nature of the FPGA 342 permits the interface between the blade controller 310 and ASIC 340 to be reprogrammable after manufacturing. Thus, for example, the blade controller 310 and ASIC 340 may be designed to have certain generic functions, and the FPGA 342 may be used advantageously to program the use of those functions in an application-specific way. The communications interface between the blade controller 310 and ASIC 340 also may be updated if a hardware design error is discovered in either module, permitting a quick system repair without requiring new hardware to be fabricated.

Also in connection with its role as the interface between computing resources and system management, the hub ASIC 340 is connected to the processors (e.g. logical CPUs) 320, 322 by way of a high-speed processor interconnect 344. In one embodiment, the processors 320, 322 are manufactured by Intel Corporation which provides the Intel® QuickPath Interconnect (“QPI”) for this purpose, and the hub ASIC 340 includes a module for communicating with the processors 320, 322 using QPI. Other embodiments may use other processor interconnect configurations.

The hub chip 340 in each blade also provides connections to other blades for high-bandwidth, low-latency data communications. Thus, the hub chip 340 includes a link 350 to the computing connection 280 that connects different blade chassis. This link 350 may be implemented using networking cables, for example. The hub ASIC 340 also includes connections to other blades in the same blade chassis 252. The hub ASIC 340 of blade 262 connects to the hub ASIC 340 of blade 264 by way of a chassis computing connection 352. The chassis computing connection 352 may be implemented as a data bus on a backplane of the blade chassis 252 rather than using networking cables, advantageously allowing the very high speed data communication between blades that is required for high-performance computing tasks. Data communication on both the inter-chassis computing connection 280 and the intra-chassis computing connection 352 may be implemented using the NumaLink protocol or a similar protocol.

In some embodiments, the hub ASIC 340 is coupled to one or more accelerators (e.g., graphics accelerators, general purpose computer accelerators, FPGAs, or other types of accelerators). As known by those in the art, an accelerator is an integrated circuitry typically dedicated to computations for computer graphics. Because its functionality is often limited to graphics processing, an accelerator is generally incapable of being self-hosted. Further, due to its specialized design, an accelerator often completes certain types of computations, such as computer graphics, faster than general purpose processors, such as processors 320, 322. During operation, the hub ASIC 340 may direct computer graphics processing tasks to an accelerator, in lieu of a processor 320, 322.

In various embodiments, the blade is configured so that multiple processors and one or more accelerators coupled to the hub ASIC 340 may access a common set of RAM on the blade. In some embodiments, an accelerator is connected to its own RAM. The results of its processing tasks may be stored in its RAM until transmitted to another component for use.

An accelerator may be electrically connected to a blade. For example, the accelerator may be connected to the hub ASIC 340 via a high-speed processor interconnect 344. In some embodiments, the accelerator is physically and electrically coupled to the blade using a local management bus 268. In this manner, the accelerator may communicate with the hub ASIC 340 of the blade without being directly attached to the blade itself.

Within the HPC system 100, only a subset of the processors (e.g., logical CPUs) may be directly coupled to one or more accelerators. FIG. 4 shows a schematic diagram of an exemplary arrangement of processor, only a subset of which are directly coupled to accelerators. In this arrangement, only processors 410, 420, 425, 435, and 445 are directly coupled to accelerators (“A”).

In some embodiments, an accelerator and a processor are directly coupled if they are connected via a PCI Express bus. In some embodiments, they are directly coupled if they are attached to one another. In various embodiments, an accelerator and processor are directly coupled if the processor is closer to the accelerator than any other processor in the partition. In further embodiments, an accelerator and processor are directly coupled if the processor is no further from the accelerator than any other processor in the partition (e.g., the closest processors to the accelerator are each the same distance away from the accelerator).

In some embodiments, directly coupled processors and accelerators are electrically connected. In other embodiments, directly coupled processors and accelerators are electrically coupled. Further, in various embodiments, any given processor may be directly coupled to more than one accelerator. One accelerator may be electrically connected to the processor while the other accelerator(s) may be electrically coupled, or any other configuration thereof.

### System Operation

System management commands generally propagate from the SMN 220, through the management connection 270 to the blade chassis (and their chassis controllers), then to the blades (and their blade controllers), and finally to the hub ASICS that implement the commands using the system computing hardware.

As a concrete example, consider the process of powering on an HPC system. In accordance with exemplary embodiments of the present invention, the HPC system 100 is powered when a system operator issues a “power on” command from the SMN 220. The SMN 220 propagates this command to each of the blade chassis 252-258 by way of their respective chassis controllers, such as chassis controller 260 in blade chassis 252. Each chassis controller, in turn, issues a “power on” command to each of the respective blades in its blade chassis by way of their respective blade controllers, such as blade controller 310 of blade 262. blade controller 310 issues a “power on” command to its corresponding hub chip 340 using the FPGA 342, which provides a signal on one of the pins of the hub chip 340 that allows it to initialize. Other commands propagate similarly.

Once the HPC system is powered on, its computing resources may be divided into computing partitions. The quantity of computing resources that are allocated to each computing partition is an administrative decision. For example, a user may have a number of projects to complete, and each project is projected to require a certain amount of computing resources. Different projects may require different proportions of processing power, memory, and I/O device usage, and different blades may have different quantities of the resources installed. The HPC system administrator takes these considerations into account when partitioning the computing resources of the HPC system 100. Partitioning the computing resources may be accomplished by programming each blade's RAM 316. For example, the SMN 220 may issue appropriate blade programming commands after reading a system configuration file.

The collective hardware computing resources of the HPC system 100 may be divided into computing partitions according to any administrative need. Thus, for example, a single computing partition may include the computing resources of some or all of the blades of one blade chassis 252, all of the blades of multiple blade chassis 252 and 254, some of the blades of one blade chassis 252 and all of the blades of blade chassis 254, all of the computing resources of the entire HPC system 100, and other similar combinations. Hardware computing resources may be partitioned statically, in which case a reboot of the entire HPC system 100 is required to reallocate hardware. Alternatively and preferentially, hardware computing resources are partitioned dynamically while the HPC system 100 is powered on. In this way, unallocated resources may be assigned to a partition without interrupting the operation of other partitions.

It should be noted that once the HPC system 100 has been appropriately partitioned, each partition may be considered to act as a standalone computing system. Thus, two or more partitions may be combined to form a logical computing group inside the HPC system 100. Such grouping may be necessary if, for example, a particular computational task is allocated more processors or memory than a single operating system can control. For example, if a single operating system can control only 64 processors, but a particular computational task requires the combined power of 256 processors, then four partitions may be allocated to the task in such a group. This grouping may be accomplished using techniques known in the art, such as installing the same software on each computing partition and providing the partitions with a VPN.

Once at least one partition has been created, the partition may be booted and its computing resources initialized. Each computing partition, such as partition 160, may be viewed logically as having a single OS 191 and a single BIOS 192. As is known in the art, a BIOS is a collection of instructions that electrically probes and initializes the available hardware to a known state so that the OS can boot, and is typically provided in a firmware chip on each physical server. However, a single logical computing partition 160 may span several blades, or even several blade chassis. A blade may be referred to as a “computing node” or simply a “node” to emphasize its allocation to a particular partition.

Booting a partition in accordance with an embodiment of the invention requires a number of modifications to be made a blade chassis that is purchased from stock. In particular, the BIOS in each blade is modified to determine other hardware resources in the same computing partition, not just those in the same blade or blade chassis. After a boot command has been issued by the SMN 220, the hub ASIC 340 eventually provides an appropriate signal to the processor 320 to begin the boot process using BIOS instructions. The BIOS instructions, in turn, obtain partition information from the hub ASIC 340 such as: an identification (node) number in the partition, a node interconnection topology, a list of devices that are present in other nodes in the partition, a master clock signal used by all nodes in the partition, and so on. Armed with this information, the processor 320 may take whatever steps are required to initialize the blade 262, including 1) non-HPC-specific steps such as initializing I/O devices 332 and non-volatile storage 334, and 2) also HPC-specific steps such as synchronizing a local hardware clock to a master clock signal, initializing HPC-specialized hardware in a given node, managing a memory directory that includes information about which other nodes in the partition have accessed its RAM, and preparing a partition-wide physical memory map.

At this point, each physical BIOS has its own view of the partition, and all of the computing resources in each node are prepared for the OS to load. The BIOS then reads the OS image and executes it, in accordance with techniques known in the art of multiprocessor systems. The BIOS presents to the OS a view of the partition hardware as if it were all present in a single, very large computing device, even if the hardware itself is scattered among multiple blade chassis and blades. In this way, a single OS instance spreads itself across some, or preferably all, of the blade chassis and blades that are assigned to its partition. Different operating systems may be installed on the various partitions. If an OS image is not present, for example immediately after a partition is created, the OS image may be installed using processes known in the art before the partition boots.

Once the OS is safely executing, its partition may be operated as a single logical computing device. Software for carrying out desired computations may be installed to the various partitions by the HPC system operator. Users may then log into the SMN 220. Access to their respective partitions from the SMN 220 may be controlled using volume mounting and directory permissions based on login credentials, for example. The system operator may monitor the health of each partition, and take remedial steps when a hardware or software error is detected. The current state of long-running application programs may be saved to non-volatile storage, either periodically or on the command of the system operator or application user, to guard against losing work in the event of a system or application crash. The system operator or a system user may issue a command to shut down application software. Other operations of an HPC partition may be known to a person having ordinary skill in the art. When administratively required, the system operator may shut down a computing partition entirely, reallocate or deallocate computing resources in a partition, or power down the entire HPC system 100.

### Assignment of Accelerators to Threads

As described herein, a user may access the HPC system 100 through a user computer 230 or a remote computer 240. From one of these terminals, the user sends a project to the SMN 220 to be completed by the HPC system 100. In turn, the HPC system 100 assigns the project to a computing partition. The computing partition determines and creates the processes for completing the project. Each process includes at least one thread, and each thread is associated with an identifier. The identifier of a thread may also be referred to herein as a “process ID” or “PID.”

The partition's operating system manages the partition's computational resources to execute the projects' processes. In some embodiments, for any given thread, an allocator selects a specific resource for running the thread (i.e., a particular processor, logical CPU, or accelerator to run the thread). Then, the allocator assigns the specified resource to the thread. In various embodiments, the allocator is part of the operating system.

Selecting the particular resource for a thread may depend on various factors. In one example, the allocator may assign the same resource to all of the threads in a process to the same resource. In another example, the allocator may assign processors and/or accelerator(s) configured to access a common set of RAM to a group of threads that operate on the same set of data. In this situation, the assignment reduces the need to store the same data redundantly.

In another example, the allocator may identify a resource running a thread that is related to the thread for which the allocator is selecting a resource. However, all of the resources on that particular blade may be unavailable (e.g., the resource is at capacity, a thread running on the resource requires its exclusive use). The allocator may search for the nearest resource on the nearest blade that is available to run the thread.

In a further example, the allocator may determine that a thread would be executed more efficiently or quickly if its computations are distributed across more than one resource. In these situations, the thread may be processing a large amount of data or performing a large number of complex computations. The resources will need to communicate with one another to coordinate running the thread. Since the resources are not directly connected, they must interface with other components that are managing various system functions (e.g., hub ASICs, computing connections). Because the resources' communication is subject to other components' loads, assigning multiple resources to a thread increases the latency of the thread's operations. Thus, assigning proximate resources to a thread can be advantageous in keeping the latency low.

When the thread is computationally extensive, for example, the allocator may assign an accelerator to the thread (e.g., in addition to a processor or logical CPU that is already assigned to the thread). In some situations, the thread requires more than one accelerator to handle its computational load. The relative scarcity of accelerators and their distribution within a partition of the HPC system 100 presents challenges in assigning resources to threads while maintaining acceptable latency for the process. In particular, latency increases with the number of components through which a communication must traverse before it reaches the receiving accelerator.

An allocator may seek to optimize the partition's efficiency by selecting an accelerator based on measurable parameters, such as the relative loads of the resource. However, the topology of the blades and their computational resources may be unknown to the allocator. The allocator cannot estimate or even account for latencies resulting from the relative positions of accelerators within the partition's topology. Thus, when the allocator selects an accelerator based on parameters that it can measure, the allocator may, in fact, be selecting a sub-optimal accelerator for jointly running a thread with another accelerator.

Likewise, the topology of the blades and their computational resources may be unknown to application programmers. When developing applications, programmers typically do not have any knowledge in advance about the topology of HPC systems that will execute their code.

To improve the HPC system's 100 allocation of accelerators, in illustrative embodiments, application programmers can instruct the allocator to select an accelerator based on a selected mode associated with a thread. Each mode corresponds to a set of selection criteria. In various embodiments, a programmer may select a mode based on the expected computational load of the thread and the relative priority of the thread, among other factors.

For example, one of the selection criteria is the location or relative location of the accelerator in the partition's topology. For a given thread, the programmer may identify the accelerator that shall run the thread. In some embodiments, the programmer may specify the accelerator that is directly coupled to a processor assigned to the thread.

The programmer may also identify a reference accelerator in the HPC system's topology from which the allocator begins searching for an accelerator to run the thread. In some embodiments, the programmer may specify the processor assigned to the thread as the location in the HPC system's topology from which the allocator shall begin its search. In some embodiments, the allocator may determine the logical CPU(s) pinned to a thread and use the logical CPU(s) to select an accelerator.

Another exemplary selection criterion is the exclusivity of the accelerator to the thread. If a thread is computationally simple or has a low or medium priority relative to other threads, by way of example, the programmer may decide that the thread may share an accelerator with other threads. In some situations, the programmer may determine that the thread is computationally complex such that exclusive use of the accelerator is necessary or desirable for finishing the computations with acceptable latency. Similarly, the programmer may determine that the thread's outputs are time sensitive such that the exclusive use of the accelerator is desirable.

Accordingly, in illustrative embodiments, the programmer, allocator, or operating system assigns one of at least four modes to a request. The modes are “Local,” “Local_Shared,” “Near,” and “Near Shared.” If a thread executes in the “Local” mode, the allocator assigns an identified accelerator to the thread and gives the thread exclusive use. If a thread executes in the “Local_Shared” mode, the allocator assigns the identified accelerator to the thread, but allows the accelerator to nm other threads. If a thread executes in the “Near” mode, the allocator begins searching for accelerators that are proximate to or near an identified processor (e.g., the processor that is running the thread). When the allocator finds an accelerator that the thread may use exclusively, the allocator assigns the accelerator to the thread. If a thread executes in the “Near_Shared” mode, the allocator searches for an accelerator, as in the “Near” mode. However, when allocator assigns the selected accelerator to the thread, the allocator allows the accelerator to run other threads. The requests function in tandem with the allocator's own algorithms for managing the allocation of accelerators among threads to improve the operating system's efficiency in managing resources.

In some embodiments, the programmer, allocator, or operating system assigns a fifth mode to a request. The mode can be an “Properties” mode. If a thread executes in the “Properties” mode, the allocator begins searching for accelerators that meet a properties criteria associated with the mode.

In operation, when a program includes an allocator request, the request includes an identifier of the thread and the mode of the thread. In some embodiments, the request includes a location within the HPC system's topology. The identifier is the process ID, or “PID” of the thread. The mode is “Local,” “Local_Shared,” “Near,” or “Near_Shared,” or any symbolic representation thereof (e.g., “00” for “Local,” “01” for “Local_Shared, “10” for “Near,” “11” for Near_Shared). In some embodiments, the mode is “Properties.” When the programmer, allocator, or operating system may select from five modes, the symbolic representation may be expanded (e.g., e.g., “000” for “Local,” “001” for “Local_Shared, “010” for “Near,” “011” for Near_Shared, “100” for Properties). The location within the HPC system's topology may be an identifier for an accelerator.

FIG. 5 is an exemplary flow diagram for processing an allocator request to assign an accelerator to a thread. When the processing begins (step 505), the allocator receives a request to assign an accelerator to a thread, based on a mode (step 510). The allocator identifies the mode in the request. Based on the mode, the allocator selects one of the algorithms for determining the accelerator that will run the thread. If the mode is “Local,” the allocator selects the “Local” algorithm (step 515) and proceeds through the steps described in FIG. 6. If the mode is “Local_Shared,” the allocator selects the “Local_Shared” algorithm (step 520) and proceeds through the steps described in FIG. 7. If the mode is “Near,” the allocator selects the “Near” algorithm (step 525) and proceeds through the steps described in FIG. 8. If the mode is “Near_Shared,” the allocator selects the “Near_Shared” algorithm (step 530) and proceeds through the steps described in FIG. 9. If the mode is “Properties,” the allocator selects the “Properties” algorithm (step 535) and proceeds through the steps described in FIG. 10.

FIG. 6 is an exemplary flow diagram for selecting an accelerator to run a thread in the “Local” mode. When the selection begins (step 605), the allocator identifies an accelerator. In some embodiments, the request includes an identifier of an accelerator. In other embodiments, the allocator determines the accelerator based on the location of the thread (e.g., the processor already assigned to the thread). For example, the allocator may identify an accelerator directly coupled to the processor assigned to the thread.

The allocator determines the availability of the accelerator for exclusive assignment to a thread (step 610). In some embodiments, the allocator determines the accelerator's availability from a record that stores information about the accelerator's load. The record may be a system file. In some embodiments, the record identifies the threads that the accelerator is running. The record may also identify threads that have been placed in the accelerator's queue, which the accelerator is not currently running. Additionally, for each thread, the record stores an indicator of the thread's exclusivity or non-exclusivity, with respect to the accelerator.

If none of the running threads require exclusive use of the accelerator, the allocator determines that the accelerator is available. If a running thread does require exclusive use, the accelerator is unavailable. Further, if any of the threads in the accelerator's queue require exclusive use, the accelerator is unavailable.

In other embodiments, the allocator determines availability by querying the accelerator regarding its ability to accept and run another thread. If the accelerator is not running any threads, the accelerator indicates that it is available. It is also available if its running threads are using the accelerator non-exclusively. However, if a running thread requires exclusive use of the accelerator, the accelerator indicates that it is unavailable.

If the accelerator is not available, then the attempt to assign an accelerator to the thread fails (step 612). In some situations, the attempt fails if another thread is already using the accelerator exclusively.

The allocator determines if the accelerator is already assigned to other threads (step 615). In some embodiments, the allocator accesses the accelerator's records to identify running threads, based on their identifiers (e.g. PIDs), that do not require exclusive use of the resource. If the accelerator is assigned to other threads, the allocator assigns a different accelerator to the threads (step 620). The allocator uncouples the threads from the original accelerator. In some embodiments, the allocator deletes these threads' entries from the accelerator's record of its load.

The allocator searches for another accelerator to execute the threads. In some embodiments, the allocator stores a list of available accelerators, such as the accelerators that are not being used exclusively by a thread. The allocator selects the accelerator on the list that is closest to the accelerator from which the threads have been uncoupled. In other embodiments, the allocator determines availability of accelerators in order of their proximity to the accelerator from which the threads have been uncoupled. The allocator continues determining such availability until it finds an accelerator that can run the threads.

Once the allocator determines another accelerator, the allocator assigns that accelerator to the threads. In some embodiments, the allocator adds information about the threads and their identifiers to the record that tracks the other accelerator's load. The other accelerator runs the threads until they are completed.

Finally, the allocator assigns the original accelerator exclusively to the thread (step 615). The allocator sends the thread identifier (e.g., the PID) and/or the thread to the accelerator. If the accelerator is available, the accelerator begins running the thread. In some embodiments, if the accelerator is unavailable, the accelerator places the thread in a queue. Once the accelerator completes execution of other threads in the queue that require its exclusive use, the accelerator begins running the thread. In other embodiments, the accelerator uncouples existing threads from the accelerator and runs the newly received thread, instead.

In some embodiments, the allocator adds an entry for the thread to the record that tracks the accelerator's load. When the accelerator is available and can run the thread exclusively, the thread's identifier and indicator of exclusive use are stored as the first entry in the record.

When the accelerator is unavailable, the thread's entry is stored among the entries associated with the accelerator's queue. The position of the thread's entry in the record may correspond to the thread's position in the accelerator's queue. In some embodiments, the information is stored at the end of the record. In other embodiments, the record orders entries for queued threads based on their times of assignment and their exclusive/non-exclusive use of the accelerator. For example, the record may store information for threads requiring exclusive use of the accelerator in the order in which they were assigned. After these entries, the record may store information for threads that permit non-exclusive use of the accelerator, also in the order of assignment. The allocator stores the entry for the newly received thread behind entries for other queued threads that require exclusive use, but before the entries of queued threads that do not. As threads complete execution, the allocator removes their entries from the record.

The accelerator runs the thread, either upon receipt of the thread or after other threads in the queue complete execution.

FIG. 7 is an exemplary flow diagram for selecting an accelerator to run a thread in the “Local_Shared” mode. When the selection begins (step 705), the allocator identifies an accelerator. In some embodiments, the request includes an identifier of an accelerator. In other embodiments, the allocator determines the accelerator based on the location of the thread (e.g., the processor already assigned to the thread). The allocator may obtain the identity of the processor assigned to the thread from the operating system. For example, the allocator may identify an accelerator directly coupled to the processor assigned to the thread.

The allocator determines the availability of the accelerator (step 710). The allocator may determine the accelerator's availability according to any of the methods described herein (e.g., analyzing a record of the accelerator's load, pinging the accelerator). If a thread already has exclusive use of the accelerator, the accelerator is unavailable. If the accelerator's load exceeds a threshold, the accelerator cannot immediately begin running the thread and is thus unavailable. In many embodiments, the resource is otherwise available.

If the accelerator is not available, then the attempt to assign an accelerator to the thread fails (step 712). In some embodiments, the accelerator places the thread in a queue. Once the accelerator completes the threads that require its exclusive use, the accelerator retrieves the thread from the queue for execution. However, if the accelerator is available, the allocator assigns the accelerator to the thread (step 715). The allocator sends the thread identifier (e.g., the PID) and/or the thread to the accelerator. If the accelerator is available, the accelerator begins running the thread. In many embodiments, the accelerator runs the thread substantially concurrently with its other threads.

In some embodiments, the allocator adds an entry for the thread to the record that tracks the accelerator's load. When the accelerator is available, the allocator stores the entry among those for running threads. When the accelerator is unavailable, the allocator stores the entry among those for queued threads. For example, the allocator may store the entry at the end of the record, since the thread is the most recently assigned one and does not require exclusive use of the accelerator. Once the accelerator completes execution of all threads that require its exclusive use, the accelerator retrieves the thread from the queue and begins running it. When the thread completes running, the allocator removes the thread's entry from the record of the accelerator's load.

FIG. 8 is an exemplary flow diagram for selecting an accelerator to run a thread in the “Near” mode. When the selection begins (step 805), the allocator identifies a location from which it shall begin searching for an accelerator. In some embodiments, the request includes an identifier of an accelerator. In other embodiments, the allocator uses the location of the thread (e.g., the processor already assigned to the thread). For example, the allocator may identify an accelerator directly coupled to the processor assigned to the thread.

The allocator determines if the accelerator is available for exclusive assignment (step 810). If the accelerator is not available, the allocator selects another accelerator in order of proximity from the request's accelerator (step 812). In some embodiments, the allocator stores a list of accelerators in the HPC system 100. The list includes information about the relative locations of the accelerators. The allocator may order the accelerators according to their proximity to the accelerator identified in the request. The allocator determines the availability of the accelerator closest to the accelerator identified in the request. If none of its running threads require exclusive use, the accelerator is available. If a running thread or a thread in the accelerator's queue requires exclusive use, the accelerator is unavailable. If the accelerator is unavailable, the allocator iteratively determines the availability of accelerators on the list (e.g., in order of proximity from the accelerator in the request) until the system finds an available resource.

Once the allocator finds an available accelerator, the allocator determines if the accelerator is assigned to other threads (step 815). In some embodiments, the allocator accesses the accelerator's records to identify running threads, based on their identifiers (e.g. PIDs), that do not require exclusive use of the resource. In light of the thread's requirement for exclusive use of the accelerator, the allocator assigns a different accelerator to the threads (step 820). The allocator selects the new accelerator according to any of the methods described herein. The allocator uncouples the threads from the accelerator. In some embodiments, the allocator deletes these threads' entries from the accelerator's record of its load. The allocator adds information about the threads and their identifiers to the record that tracks the other accelerator's load. The other accelerator runs the threads until they are completed.

Then, the allocator assigns the original accelerator to the thread (step 815). The allocator sends the thread identifier (e.g., the PID) and/or the thread to the accelerator. The accelerator begins running the thread. The allocator adds an entry for the thread to the record that tracks the accelerator's load, as described herein.

FIG. 9 is an exemplary flow diagram for selecting an accelerator to run a thread in the “Near_Shared” mode. When the selection begins (step 905), the allocator identifies a location from which it shall begin searching for an accelerator. In some embodiments, the request includes an identifier of an accelerator. In other embodiments, the allocator uses the location of the thread (e.g., the processor already assigned to the thread). For example, the allocator may identify an accelerator directly coupled to the processor assigned to the thread.

The allocator determines if the accelerator is available (step 910). If the accelerator is not available, the allocator selects another accelerator in order of proximity from the request's accelerator (step 812). In some embodiments, the allocator stores a list of accelerators in the HPC system 100. The list includes information about the relative locations of the accelerators. The allocator may order the accelerators according to their proximity to the accelerator identified in the request. The allocator determines the availability of the accelerator closest to the accelerator identified in the request.

Because the thread does not require exclusive use of the resource, the thread simply needs an accelerator that can accept another thread for execution. If a thread already has exclusive use, the accelerator is unavailable. If the accelerator's load exceeds a threshold, the accelerator does not accept additional threads and is thus unavailable. In many embodiments, the resource is otherwise available. If the accelerator is unavailable, the allocator iteratively determines the availability of accelerators on the list (e.g., in order of proximity from the accelerator in the request) until the system finds an available resource.

Once the allocator identifies an available accelerator, the allocator assigns the accelerator to the thread (step 915). The allocator sends the thread identifier (e.g., the PID) and/or the thread to the accelerator. The accelerator begins running the thread. In many embodiments, the accelerator runs the thread substantially concurrently with its other threads. In some embodiments, the allocator adds an entry for the thread to the record that tracks the accelerator's load. When the thread completes running, the allocator removes the thread's entry from the record of the accelerator's load.

FIG. 10 is an exemplary flow diagram for selecting an accelerator to run a thread in the “Properties” mode. When the selection begins (step 1005), the allocator identifies a location from which it shall begin searching for an accelerator. In some embodiments, the request includes an identifier of an accelerator. In other embodiments, the allocator uses the location of the thread (e.g., the processor already assigned to the thread). For example, the allocator may identify an accelerator directly coupled to the processor assigned to the thread.

The allocator determines if the accelerator is available (step 1010). If the accelerator is not available, the allocator selects another accelerator in order of proximity from the request's accelerator (step 1012). In some embodiments, the allocator stores a list of accelerators in the HPC system 100. The list includes information about the relative locations of the accelerators. The allocator may order the accelerators according to their proximity to the accelerator identified in the request. The allocator determines the availability of the accelerator closest to the accelerator identified in the request.

Because the thread does not require exclusive use of the resource, the thread simply needs an accelerator that can accept another thread for execution. If a thread already has exclusive use, the accelerator is unavailable. If the accelerator's load exceeds a threshold, the accelerator does not accept additional threads and is thus unavailable. In many embodiments, the resource is otherwise available. If the accelerator is unavailable, the allocator iteratively determines the availability of accelerators on the list (e.g., in order of proximity from the accelerator in the request) until the system finds an available resource.

If the accelerator is available, the allocator determines if the accelerator meets aproperties criteria (step 1014). The properties criteria may be based on energy consumption, load, accelerator performance characteristics (e.g., integer or floating point intensive), accounting cost, load imbalance in the parallel application, or any combination thereof, or any other criteria as would be appreciated by one of ordinary skill in the art. In some embodiments, the properties criteria may be one or more thresholds related to energy consumption or load. The allocator may meet the properties criteria if its energy consumption and/or load falls below a predetermined threshold. In some embodiments, the properties criteria may be based on floating point performance characteristics. If the accelerator can handle floating point intensive computations, the accelerator meets the properties criteria. If the accelerator does not meet the properties criteria, the allocator selects another accelerator in order of proximity from the request's accelerator (step 1012).

Once the allocator identifies an available accelerator that meets the properties criteria, the allocator assigns the accelerator to the thread (step 1015). The allocator sends the thread identifier (e.g., the PID) and/or the thread to the accelerator. The accelerator begins running the thread. In many embodiments, the accelerator runs the thread substantially concurrently with its other threads. In some embodiments, the allocator adds an entry for the thread to the record that tracks the accelerator's load. When the thread completes running, the allocator removes the thread's entry from the record of the accelerator's load.

In various embodiments, after the allocator assigns an accelerator to a thread, the accelerator begins running the thread. In some embodiments, running a thread on an accelerator includes migrating an operating system (OS) thread to the accelerator. In various embodiments, running the thread on the accelerator includes one or more operating system activities such as sending a computational work request to the accelerator, copying data and instructions to and from the accelerator, assigning a computational resource or thread within the accelerator itself to the thread, and/or waiting for the accelerated computation to complete. In some embodiments, running the thread includes any operating system activity for offloading.

In some embodiments, one thread may allocate an accelerator on behalf of an HPC application that includes many distributed threads. The application may use the allocated accelerator by launching additional threads explicitly onto the accelerator using, by way of example, Message Passing Interface or a similar parallel job launcher.

The disclosed apparatus and methods may be implemented as a computer program product for use with a computer system. Such implementation may include a series of computer instructions fixed either on a tangible medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or allocators. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a tangible removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Of course, some embodiments of the invention may be implemented as a combination of both software (e.g., a computer program product) and hardware. Still other embodiments of the invention are implemented as entirely hardware, or entirely software. The embodiments of the invention described above are intended to be merely exemplary; numerous variations and modifications will be apparent to those skilled in the art. All such variations and modifications are intended to be within the scope of the present invention as defined in any appended claims.

Although the above discussion discloses various exemplary embodiments of the invention, it should be apparent that those skilled in the art can make various modifications that will achieve some of the advantages of the invention without departing from the true scope of the invention.

What is claimed is:

1. A method of distributing threads among accelerators in a high performance computing system, the method comprising:
receiving, by an allocator, a request to assign an accelerator in the computing system to a thread, the request including a mode indicative of location and exclusivity of the accelerator for use by the thread;
selecting, by the allocator, the accelerator according to a processor assigned to the thread; and
assigning, by the allocator, the accelerator to the thread with the exclusivity specified in the request.

2. The method of claim 1, wherein receiving the request comprises receiving an identifier of the accelerator to assign to the thread.

3. The method of claim 2, further comprising:
determining, by the allocator, from the mode that the thread requires exclusive use of the accelerator; and
storing, by the allocator, a record indicating the thread to which the accelerator is exclusively assigned.

4. The method of claim 3, further comprising:
uncoupling, by the allocator, threads that are already executing on the accelerator from the accelerator;
selecting, by the allocator, a second accelerator to execute the threads; and
assigning, by the allocator, the second accelerator to the threads.

5. The method of claim 1, wherein receiving the request comprises receiving a reference accelerator from which the allocator begins searching for the accelerator to assign to the thread.

6. The method of claim 5, wherein selecting the accelerator comprises
determining, by the allocator, that an accelerator proximate to the reference accelerator is available.

7. The method of claim 6, wherein determining if the accelerator proximate to the reference accelerator is available comprises
reading, by the allocator, a record that stores a status of the accelerator.

8. The method of claim 5, wherein selecting the accelerator comprises
iteratively determining, by the allocator, availability of accelerators in order of proximity to the reference accelerator until an available accelerator is found.

9. The method of claim 8, further comprising:
determining, by the allocator, from the mode that the thread requires exclusive use of the accelerator; and
storing, by the allocator, a record indicating that the accelerator is unavailable.

10. The method of claim 9, further comprising:
uncoupling, by the allocator, threads that are already executing on the accelerator from the accelerator;
selecting, by the allocator, a second accelerator to execute the threads; and
assigning, by the allocator, the second accelerator to the threads.

11. The method of claim 1, further comprising:
receiving, by the allocator, a second request to assign an accelerator in the computing system to a thread, the second request including a mode indicative of at least one property of the accelerator for use by the thread;
selecting, by the allocator, the accelerator according to the at least one property of the mode; and
assigning, by the allocator, the accelerator with the at least one property of the mode to the thread.

12. A high performance computer system having at least one partition, the partition having a plurality of nodes that cooperate to perform a computation, a plurality of the nodes in the partition, each node comprising:
at least one computing processor, and
a local memory, coupled to the at least one computing processor;
a subset of the computer processors being directly coupled to at least one accelerator; and
an allocator of the partition configured to be executed by at least one computing processor that is configured to 1) receive a request to assign an accelerator in the computing system to a thread, the request including a mode indicative of location and exclusivity of the accelerator for use by the thread, 2) select the accelerator according to a processor assigned to the thread, and 3) assign the accelerator to the thread with the exclusivity specified in the request.

13. The high performance computer system of claim 12, wherein the allocator is configured to receive an identifier of the accelerator to assign to the thread.

14. The high performance computer system of claim 13, wherein the allocator is configured to determine from the mode that the thread requires exclusive use of the accelerator, and store a record indicating the thread to which the accelerator is exclusively assigned.

15. The high performance computer system of claim 14, wherein the allocator is configured to uncouple threads that are already executing on the accelerator from the accelerator, select a second accelerator to execute the threads, and assign the second accelerator to the threads.

16. The high performance computer system of claim 12, wherein the allocator is configured to receive a reference accelerator from which the allocator begins searching for the accelerator to assign to the thread.

17. The high performance computer system of claim 16, wherein the allocator is configured to determine that an accelerator proximate to the reference accelerator is available.

18. The high performance computer system of claim 17, wherein the allocator is configured to read a record that stores a status of the accelerator.

19. The high performance computer system of claim 16, wherein the allocator is configured to iteratively determine availability of accelerators in order of proximity to the reference accelerator until an available accelerator is found.

20. The high performance computer system of claim 19, wherein the allocator is configured to determine from the mode that the thread requires exclusive use of the accelerator, and store a record indicating that the accelerator is unavailable.

21. The high performance computer system of claim 20, wherein the allocator is configured to uncouple threads that are already executing on the accelerator from the accelerator, select a second accelerator to execute the threads, and assign the second accelerator to the threads.

22. The high performance computer system of claim 12, wherein the allocator is further configured to 1) receive a second request to assign an accelerator in the computing system to a thread, the second request including a mode indicative of at least one property of the accelerator for use by the thread, 2) select the accelerator according to the at least one property of the mode, and 3) assign the accelerator with the at least one property of the mode to the thread.

23. A computer program product for distributing threads among accelerators in a partition of a high performance computing system, the partition having a plurality of nodes that cooperate to perform a computation, each node in the partition comprising at least one computing processor and a memory, the computer program product having a computer usable medium with non-transitory computer readable program code thereon, the program code comprising program code for:
receiving a request to assign an accelerator in the computing system to a thread, the request including a mode indicative of location and exclusivity of the accelerator for use by the thread;
selecting the accelerator according to a processor assigned to the thread; and
assigning the accelerator to the thread with the exclusivity specified in the request.

24. The computer program product of claim 23, the program code further comprising program code for:
receiving an identifier of the accelerator to assign to the thread.

25. The computer program product of claim 24, the program code further comprising program code for:
determining from the mode that the thread requires exclusive use of the accelerator; and
storing a record indicating the thread to which the accelerator is exclusively assigned.

26. The computer program product of claim 25, the program code further comprising program code for:
uncoupling threads that are already executing on the accelerator from the accelerator;
selecting a second accelerator to execute the threads; and
assigning the second accelerator to the threads.

27. The computer program product of claim 23, the program code further comprising program code for:
receiving a reference accelerator from which the allocator begins searching for the accelerator to assign to the thread.

28. The computer program product of claim 27, the program code further comprising program code for:
determining that an accelerator proximate to the reference accelerator is available.

29. The computer program product of claim 28, the program code further comprising program code for:
reading a record that stores a status of the accelerator.

30. The computer program product of claim 27, the program code further comprising program code for:
iteratively determining availability of accelerators in order of proximity to the reference accelerator until an available accelerator is found.

31. The computer program product of claim 30, the program code further comprising program code for:
determining from the mode that the thread requires exclusive use of the accelerator; and
storing a record indicating that the accelerator is unavailable.

32. The computer program product of claim 31, the program code further comprising program code for:
uncoupling threads that are already executing on the accelerator from the accelerator;
selecting a second accelerator to execute the threads; and
assigning the second accelerator to the threads.

33. The computer program product of claim 23, the program code further comprising program code for:
receiving a second request to assign an accelerator in the computing system to a thread, the second request including a mode indicative of at least one property of the accelerator for use by the thread;
selecting the accelerator according to the at least one property of the mode; and
assigning the accelerator with the at least one property of the mode to the thread.
